(19) United States
(12) Patent Application Publication
(10) Pub. No.: US 2002/0184406 A1
(43) Pub. Date: Dec. 5, 2002

(54) Method and system for handling window-based graphical events

(75) Inventor: Salvo Aliffi, Rome (IT)

Correspondence Address: Leslie A. Van Leeuwen, International Business Machines Coporation, Intellectual Property Law Department, 11400 Burnet Road, Austin, TX, 78758, US

(73) Assignee: International Business Machines Corporation, Armonk, NY

(21) Appl. No.: 10/116,589

(22) Filed: Apr. 4, 2002

(30) Foreign Application Priority Data
May 29, 2001 (EP) 01480037.9

(51) Int. Cl. G06F 9/46

(52) U.S. Cl. 709/318

(57) ABSTRACT

A method and system for controlling access to window based applications for a user logged on a workstation. The method comprises a first step of collecting user information including a list of events and their corresponding action; the collection can be done on the user workstation or from the system administrator workstation. The second step is for creating a user profile file with the user information on the workstation; this file can be sent from the system administrator workstation to the user workstation. The third step is for starting the user access application on the workstation wherein a user is logged on; for each event occurring in the process of a window based application started on the workstation, capturing it and checking it against said list of events and their corresponding action in the user profile file; proceeding with the process execution if the captured event is not stored in the user profile; the event may be the title of a window or a name of an application. The last step is for executing the action corresponding to the captured event if it has been identified in the user profile file. The action can be preventing the user from proceeding with the execution of the window based application.

### FIELD OF THE INVENTION

The present invention generally relates to the field of graphical user interface; more particularly the invention applies to control of access to window-based applications.

### BACKGROUND OF THE INVENTION

Access control to window-based applications can be critical when workstations where these applications are executed are shared by many users having not all the same access profile. It is for instance the case during fairs when workstations are in demonstration on booths and let in free access to the public. It happens also that, internally to a company or a university, free access is given to a pool of workstations but not for all the window-based applications. It could be also desirable to differentiate access to different transaction inside a same application.

The usual control access provided by the computer manufacturers in the operating system is based on an access control to data files. It is true that all the applications use data file and controlling the access to data files allows controlling access to the applications using them. This is the solution provided by Windows NT File System NTFS where each file or folder is given an “access control list” for users of groups of users. However, it is sometimes difficult to associate a particular folder or file to an application or even to a transaction in an application. Furthermore, the file system solution does not apply to the applications not using the file system, one example of such application being a web browser.

### SUMMARY OF THE INVENTION

It is an object of the present invention to provide a method for controlling the access to a window based application or to a transaction part of a window based application.

A further object is to have a simple method to manage such accesses.

The objects are reached by the use of a method for controlling user access to window based applications on a workstation, said method comprising the steps of:

collecting user information including a list of events and their corresponding action;

creating a user profile file with the user information on the workstation;

starting the user access application on the workstation wherein a user is logged on;

for each event occurring in the process of a window based application started on the workstation, capturing it and checking it against said list of events and their corresponding action in the user profile file;

proceeding with the process execution if the captured event is not stored in the user profile;

executing the action corresponding to the captured event if it has been identified in the user profile file.

With the solution of the present invention based on access control to windows, the user can be barred from accessing either an entire application or a specific transaction or any action inside a given transaction. This gives a simple and detailed level of control for complex applications having accesses shared by the public or privilege customers or professionals such as applications operating in financial organizations.

### BRIEF DESCRIPTION OF THE DRAWINGS

FIG. 1 illustrates one computing environment of the preferred embodiment;

FIG. 2 is the general flow chart of the solution according to the preferred embodiment;

FIG. 3 illustrates the execution environment of the access control application according to the preferred embodiment;

FIG. 4 is the block diagram of the Hooking module, one component of the access control application according to the preferred embodiment;

FIG. 5 is the printed screen of the first dialog box of the application for entering and storing the user profiles according to the preferred embodiment;

FIG. 6 is the printed screen of the Profile selection form of the application for accessing the user profiles according to the preferred embodiment;

FIG. 7 is the printed screen of a first Profile entry form for event selection when an application name has been selected;

FIG. 8 is the printed screen of a second Profile entry form for event selection when a Window title has been selected.

### DESCRIPTION OF THE PREFERRED EMBODIMENT

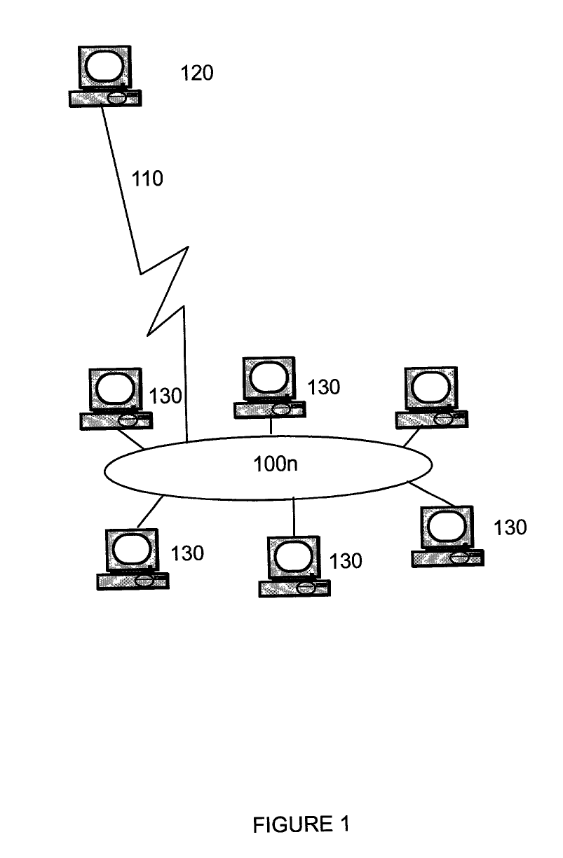

FIG. 1 illustrates an environment including workstations (110) connected through a Local Area Network (LAN) (100), where the users can access only a selected set of the window based applications executing on these workstations. The LAN of FIG. 1 could be installed in a booth at a fair and the workstations freely accessed by the visitors. This LAN could be also installed in a computing room freely accessed by students in a University. A remote workstation (120) communicating with the LAN through a network line is the workstation of the system administrator which controls access to the applications operating on the LAN. The access control data are downloaded from the system administrator workstation to the LAN workstations. On each LAN workstation is started a user access control application to the window based applications operating on the workstation, using the access control data downloaded from the system administrator workstation. Preferably, the user access control applications are started by the system administrator on each workstation. One other solution would be that the user access application is automatically started on the LAN workstations to be controlled each time a user starts it.

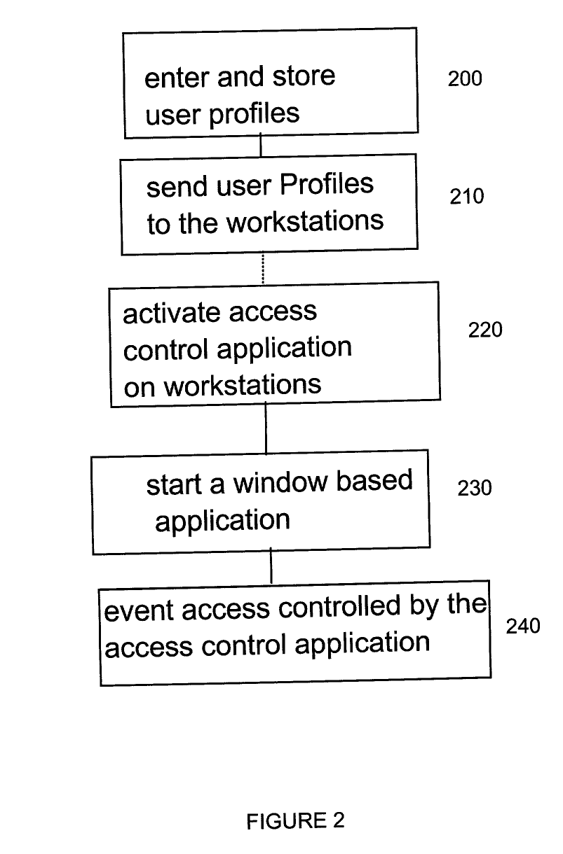

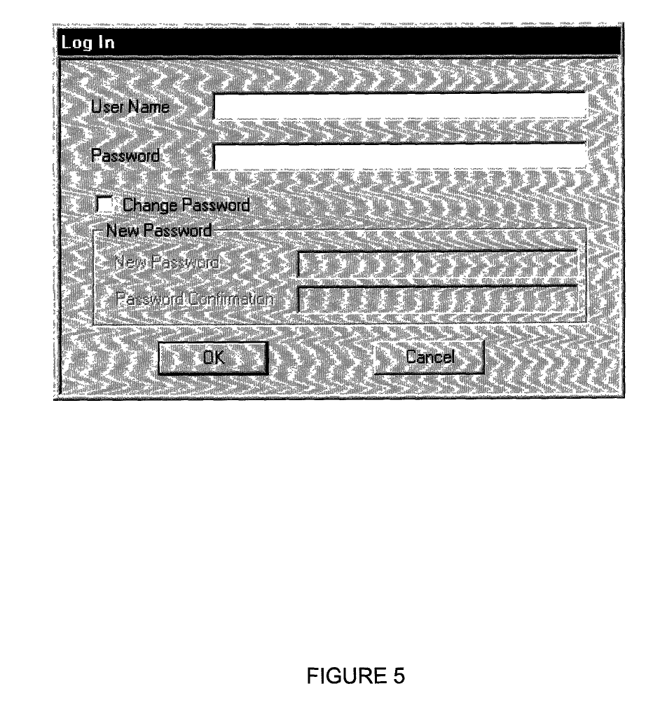

FIG. 2 shows the general flow chart of the method for providing user access control to window based applications according to the preferred embodiment. The first step (200) consists in interactively seizing user access control data on a workstation having Windows NT of Microsoft Corporation as operating system, and creating, different user profiles binary files. In the preferred embodiment the first step is performed by the system administrator on a remote system administrator workstation. The user profile entry is described later in FIGS. 5, 6, 7 and 8.

In the second step (210), the user profile binary files are sent by the system administrator to the workstations of the LAN on which a user access control application will operate.

The third step consists in activating the user access control application on the LAN workstations. In the preferred embodiment the user access control application is started and stopped from the system administrator workstation. According to the well known application management on Windows NT or equivalent operating systems, the user access control application is first automatically activated as a service at boot time on a LAN workstation. Once activated, the application serves requests from the network and such as Start and Stop. The system administrator will send Start and Stop requests to activate and stop the user access control application. The Start and Stop request can be processed on a LAN workstation only with the use of the user name and password.

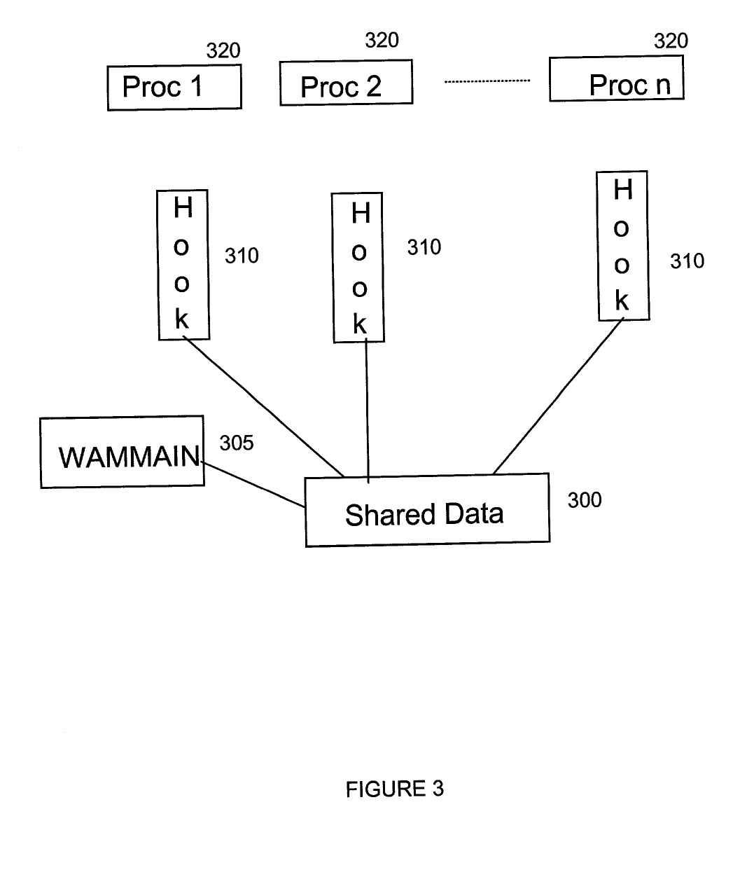

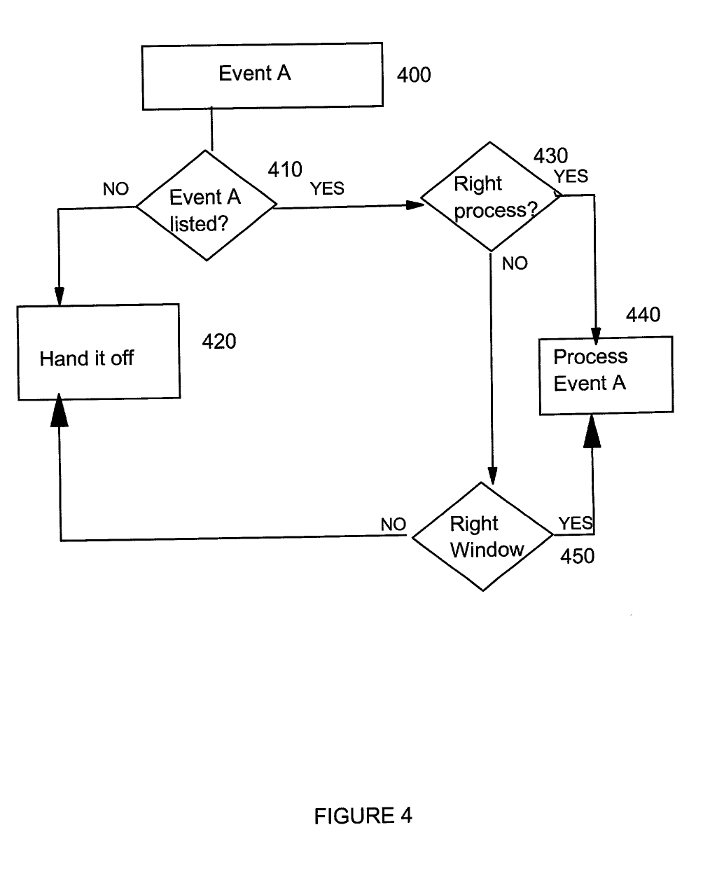

Once the user access control application is started on a workstation, each time the user of the workstation starts a window based application (230), this window based application will be submitted to the control of the access control application (240). According to the user profile, the user will be authorized by the user access control application to access or not a window, an application or a specific action in a window or an application. This last step is described in greater details with the comments on FIG. 3 and FIG. 4.

The software architecture of the access control application of the preferred embodiment is made up of three components which are the user interface module, the hooking module and the shared data module.

The user interface module is a graphical application which collects the user data and creates the user profile binary files (200). In the preferred embodiment this component is only installed on the system administrator workstation. One other solution is to create the user profile binary file one each LAN workstation and, in this case, the corresponding component is installed on these workstations.

The shared data module is a component communicating used by the other two components of the application as it provides access to the user profile binary files.

The hooking module captures the events of window based applications and performs the user access control by analyzing the captured events.

FIG. 3 describes the execution environment of the user access control application. An instance of the hooking module (310) is loaded in every process (320), each process corresponding to an activated window based application which is controlled on the workstation. Each of these hooking modules checks all graphical events that occur in the process where it is operating. Each event is checked against what is specified in the corresponding user profile binary file of the shared data (300). More particularly for each event that it captures, the Hooking module checks whether the given event is listed in the user profile binary file which is the shared data (300) accessed through the shared data module access methods (not represented here). The Hooking module processes therefore each event before passing back to the owning process.

In FIG. 3, the WAMMAIN process which is the main process of the user access control application, it comprises the shared data module and, optionally, the user interface module.

FIG. 4 is the block diagram of the hooking module operating in each active graphical process. When a event occurs (event A, 400), it is systematically sent to the Hooking Module. The Hooking Module compares this event to each of the list of events corresponding of the user profile. This list of event is stored as Shared Data the access to the data is given by the Shared Data module activated in the main process WAMMAIN. The events can be listed in the Shared Data as either a window title related event or a process related event. A window title related event is an event that occurs on a window whose title is somehow specified. A window title can be specified indicating the whole title, the string that starts the title or a string contained in the title. A process related event is instead an event that occurs on any window belonging to the specified process name. Thus, every time an event occurs, it is checked against both lists and if it is found, the related action (in the preferred embodiment it is to inhibit it) is performed. If this event is not listed (answer no to test 410), Event A is handed off to the owning process for further execution (420). If this event is listed (answer yes to test 410), a checking is performed on the process name attached to this event in the Shared Data record just read. If the process is the same than the process owning Event A (answer yes to test 430), Event A is processed according to the policy defined in the Shared Data for it. In the preferred embodiment the process execution is inhibited for that user. If the process is not the same (answer no to test 430), a checking is performed on the window name attached to this event in the Shared Data record just read. If the window is the same than the window of Event A (answer Yes to test 450), Event A is processed according to the policy defined in the Shared Data for it. In the preferred embodiment the process execution is inhibited for that user. If the window is not the same (answer No to test 450), Event A is handed off to the owning process for further execution.

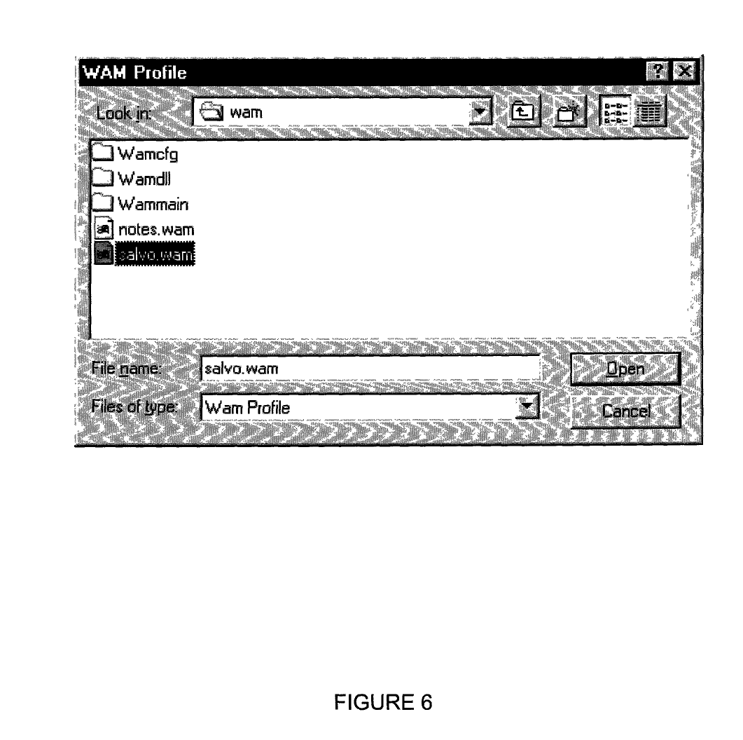

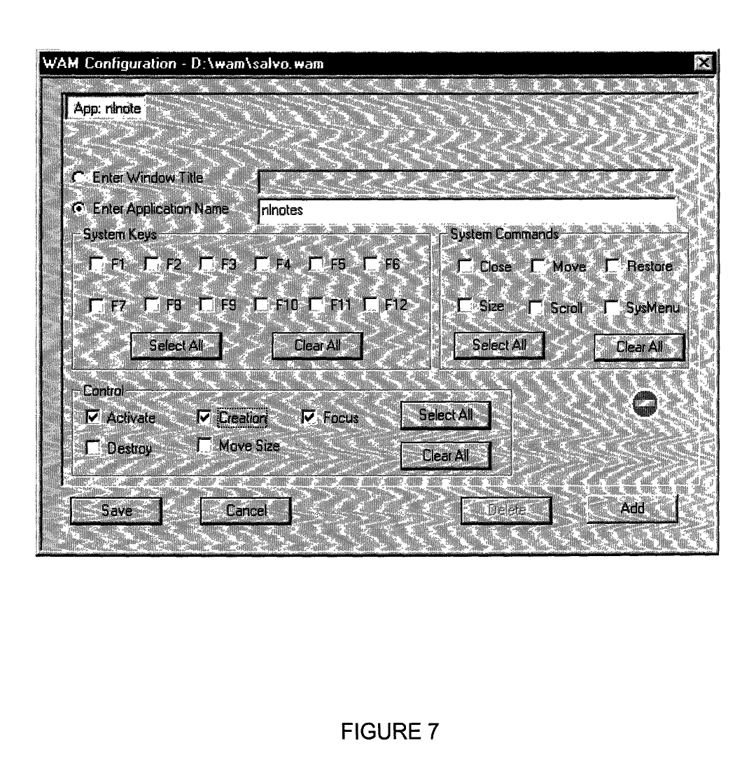

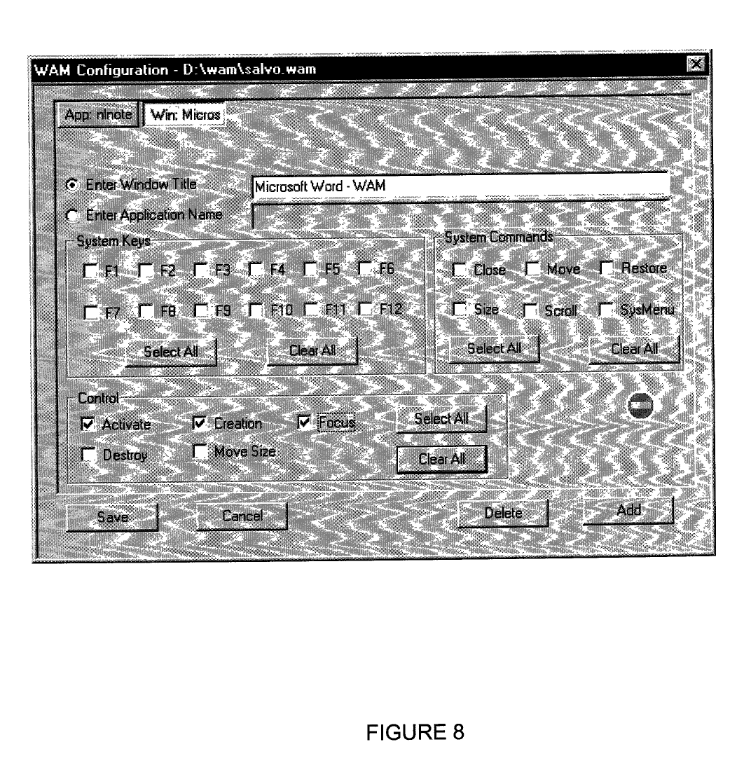

FIG. 5 is a printed screen of the first dialog box of the user profile entry application run by the system administrator. A user name and password are entered as well as, if necessary, a field to request a change in password as usually done when password are used. Once logged on, the system administrator can create a profile or open a previously created one. A profile is a list of up to 10 forms in the preferred embodiment, which specify which events are to be inhibited. FIG. 6 is the printed screen for the Profile selection. The profile ‘salvo.Wam’ which is a Window Word file belonging to the docket wam has been selected. FIG. 7 is the printed screen for the Profile entry. Either an Application name or a Window title can be selected. Consequently, on the Profile form, events can be inhibited for an application or for any window whose title starts with the specified string of characters. The forms allows also entering which kind of event are to be inhibited. In FIG. 7 Activate, Creation and Focus events are to be inhibited in any window belonging to the application nlnotes (Lotus Notes). The Profile form is saved by checking on the Save button. By clicking on the Add button, a second Profile form can be filled. FIG. 8 is the printed screen of the second Profile form filled for the same user. In this second Profile form the “Microsoft Word—Wam” character string is entered in the Window Title field and the Activate, Creation and Focus events are selected. This second form must be saved as well. One exits the user profile entry application by clicking on the “cancel” button. At this point in time the user Profile binary file is created and can be downloaded in workstations. With the Profile of FIGS. 7 and 8, the corresponding user will not be able to start (Creation event) or move to foreground (Activate and Focus events) Lotus Notes and Microsoft Word applications.

As illustrated in the Profile forms of FIG. 7 and FIG. 8, three groups of events are selectable in the preferred embodiment. The first group is the group of ‘System keys’. The System keys are activated by hitting ALT+Function key on the key pad of the workstation. These events may be used by applications as well as by windows. The second group is the group of System commands. These commands are generated when acting on a system menu. These events may be used by applications. The third group of Control events are events of the windows and are applicable to both applications or windows.

When a user Profile is created and loaded in a workstation, the access control application can be started.

The preferred embodiment is only one possible implementation of the present invention. The person skilled in the art can adapt the solution to any other operating system able to handle events, any other application to enter the user profile in a centralized manner as described or on each workstation to be access controlled. Also the kind of events to be handled can be adapted to the kind of application or computing equipment. The solution maybe implemented as a standalone program or a program included as a complement of one other program.

Extensions of the solution can also be considered by the use of Plugins. As a matter of fact with the preferred embodiment the events are captured, analyzed and if relevant the access of the user to the window based application is inhibited. By expanding this process with plugins, the system administrator can decide what to do. For instance, a Plugin could send an event to an event handler for further processing. A plugin could also allow integration with another program or allow integration with a program analyzer.

1. A method for controlling user access to window based applications on a workstation, said method comprising the steps of:
collecting user information including a list of events and their corresponding action;
creating a user profile file with the user information on the workstation;
starting the user access application on the workstation wherein a user is logged on;
for each event occurring in the process of a window based application started on the workstation, capturing it and checking it against said list of events and their corresponding action in the user profile file;
proceeding with the process execution if the captured event is not stored in the user profile;
executing the action corresponding to the captured event if it has been identified in the user profile file.

2. The method of claim 1 wherein the action corresponding to an event identified in the user profile file is to prevent the user from proceeding with the process execution.

3. The method of claim 1 or 2 wherein the collecting step is executed on a different workstation from the user workstation.

4. The method of anyone of claims 1 to 3 wherein the creating step is performed by sending the user profile file from a different workstation from the user workstation.

5. The method of anyone of claims 1 to 4 where the starting step is executed from a remote workstation connected via a network line to the user workstation.

6. The method of anyone of claims 1 to 5 wherein an event of the list of events is characterized by a window title characterizing a window based application.

7. The method of claim 6 where the window title is the whole title or the character string starting the title or a character string included in the title.

8. The method of anyone of claims 1 to 5 wherein an event of the list of events is characterized by any event belonging to a given window based application executing on the user workstation.

9. The method of anyone of claims 1 to 8 wherein the collecting step is performed interactively using a graphical user interface.

10. A computer program product comprising programming code instructions for executing the steps of the method according to any of the claims 1 to 9 when said program is executed on a computer.

11. A system comprising a workstation having an operating system enabling execution of window based applications, and executing a program product comprising programming code instructions executing the steps of the method according to any of the claims 1 to 9.
